(19) United States
(12) Patent Application Publication
(10) Pub. No.: US 2010/0302699 A1
(43) Pub. Date: Dec. 2, 2010

(54) ELECTRICAL FUSE CIRCUIT AND METHOD OF OPERATING THE SAME

(75) Inventor: Masayuki Minami, Kanagawa (JP)

Correspondence Address: YOUNG & THOMPSON, 209 Madison Street, Suite 500, Alexandria, VA, 22314, US

(73) Assignee: NEC Electronics Corporation, Kanagawa (JP)

(21) Appl. No.: 12/784,875

(22) Filed: May 21, 2010

(30) Foreign Application Priority Data
May 27, 2009 (JP) 2009-127635

(51) Int. Cl. H02H 5/04

(52) U.S. Cl. 361/104

(57) ABSTRACT

An electrical fuse circuit is provided with: a protection element having a first terminal connected to a power source and outputting a fusing voltage from a second terminal; an electrical fuse having a third terminal connected to the second terminal of the protection circuit; and a fusing transistor connected between the electrical fuse and ground to switch a current through the electrical fuse. The second terminal of the protection element is connected to a gate of the fusing transistor.

### INCORPORATION BY REFERENCE

This application claims the benefit of priority based on Japanese Patent Application No. 2009-127635, filed on May 27, 2009, the disclosure of which is incorporated herein by reference.

### BACKGROUND OF THE INVENTION

1. Field of the Invention

The present invention relates to an electrical fuse circuit and a method of operation the same.

2. Description of the Related Art

Semiconductor devices often incorporate electrical fuses. For example, electrical fuses are used for a programming device storing therein redundancy data and identification codes. An electrical fuse is blown by injecting a current into the electrical fuse. In general, an electrical fuse power source and a fusing transistor are provided to inject a current into the electrical fuse. The electrical fuse power source supplies a power source voltage to the electrical fuse. The fusing transistor is connected to the electrical fuse so as to switch the injection current into the electrical fuse. In blowing a target electrical fuse, the electrical fuse power source is started and the fusing transistor connected to the target electrical fuse is turned on. This results in that a current is applied through the target electrical fuse to blow the electrical fuse.

Japanese Patent Application Publication No. 2008-153588 discloses an example of an electrical fuse circuit, which is illustrated in FIG. 1. The gate of a MOS transistor 112, which is serially connected to a fuse element 111, is controlled by an AND circuit 113 which is connected to the same power source as that connected to the fuse element 111. In blowing the fuse element 11, one input of the AND circuit 113 is pulled down to the ground. The circuit configuration shown in FIG. 1 effectively avoids the programming error of the fuse element 111, when a power source is turned on or off in a system LSI.

One issue of the conventional electrical fuse circuit shown in FIG. 1 is difficulty in surely blowing the electrical fuse. This results from the following reason: In the conventional electrical fuse circuit, the voltage applied to the gate of the fusing transistor 112 is a constant voltage supplied from the power source. After a current is started to be injected into the electrical fuse to blow the electrical fuse, the resistance value of the electrical fuse increases as time goes on from the start of the current injection. The amount of current applied to the electrical fuse decreases due to the increase of the resistance value. This undesirably makes it difficult to surely blow the electrical fuse.

### SUMMARY

In an aspect of the present invention, an electrical fuse circuit is provided with: a protection element having a first terminal connected to a power source and outputting a fusing voltage from a second terminal; an electrical fuse having a third terminal connected to the second terminal of the protection circuit; and a fusing transistor connected between the electrical fuse and ground to switch a current through the electrical fuse. The second terminal of said protection element is connected to a gate of the fusing transistor.

The present invention provides a circuit and method which allow surely blowing the electrical fuse.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a circuit diagram showing a conventional electrical fuse circuit;

FIG. 2 is a schematic circuit diagram of an electrical fuse circuit in one embodiment of the present invention;

FIG. 3 is a graph showing an exemplary time-dependent change in the current through the electrical fuse when the conventional electrical fuse circuit is used; and

FIG. 4 is a graph showing an exemplary time-dependent change in the current through the electrical fuse when the electrical fuse circuit of the present invention is used.

### DESCRIPTION OF PREFERRED EMBODIMENTS

An embodiment of the present invention will be described hereinafter referring to the drawings.

FIG. 2 is a schematic circuit diagram showing an electrical fuse circuit 1 in one embodiment of the present invention. This electrical fuse circuit 1 is used for, for example, a programming device storing redundancy data of a memory array or inherent IDs.

As shown in FIG. 2, the electrical fuse circuit 1 is a provided with a protection element 3, an electrical fuse 4, a fusing transistor 5 and a fusing enable circuit 6.

One terminal of the protection element 3 is connected to a power source 2. The protection element 3 receives a power source voltage from the power source 2 on one terminal, and outputs a fusing voltage from the other terminal. For example, a resistance element made of polysilicon may be used as the protection element 3.

The electrical fuse 4 is blown if necessary. One terminal of the electrical fuse 4 is connected to the protection element 3.

The fusing transistor 5 is provided to switch the current through the electrical fuse 4. The fusing transistor 5 is provided between the other terminal of the electrical fuse 4 and the ground. When the fusing transistor 5 is turned on, a current is applied through the electrical fuse 4 toward the ground. When the fusing transistor 5 is turned off, no current is applied to the electrical fuse 4.

The fusing enable circuit 6 is provided to switch the fusing transistor 5. The fusing enable circuit 6 is provided between the other terminal of the protection element 3 and the gate of the fusing transistor 5. When enabled, the fusing enable circuit 6 feeds the fusing voltage outputted from the other terminal of the protection element 3 to the gate of the fusing transistor 5. When disabled, the fusing enable circuit 6 feeds a ground voltage to the gate electrode of the fusing transistor 5. The fusing enable circuit 6 is responsive to a fusing enable signal. That is, the fusing enable circuit 6 switches the voltage to be fed to the gate of the fusing transistor 5, depending on the logic level of the fusing enable signal.

In one embodiment, a CMOS circuit including a PMOS transistor 7-1 and NMOS transistor 7-2 may be used as the fusing enable circuit 6. The PMOS and NMOS transistors 7-1 and 7-2 are responsive to the fusing enable signal to feed the fusing voltage to the gate electrode of the fusing transistor 5. It should be noted, however, that the fusing enable circuit 6 is not limited to the CMOS circuit. An alternative circuit configured differently from the CMOS circuit may be used as the fusing enable circuit 6 as long as the alternative circuit provides similar functions.

Next, a description is given of a method of operating the electrical fuse circuit 1 in this embodiment.

First, the power source 2 is started. This is followed by pulling up or asserting the fusing enable signal, which is fed to the fusing enable circuit 6. In response to the fusing enable signal, the fusing enable circuit 6 feeds the fusing voltage outputted from the other terminal of the protection element 3 to the gate of the fusing transistor 5. As a result, the fusing transistor 5 is turned on.

When the fusing transistor 5 is turned on, a current is applied to the electrical fuse 4 to blow the electrical fuse 4.

It should be noted that the fusing enable signal is asserted during a predetermined period. After this period, the fusing enable signal is pulled down or negated to thereby turn off the fusing transistor 5.

When the electrical fuse 4 is blown, a transitional high current such as a surge current may be generated in the power source 2 due to a rapid change in the resistance value of the electrical fuse 4. The circuit configuration of this embodiment, in which the protection element 3 is provided between the power source 2 and the electrical fuse 4, effectively protects the power source 2 from the transitional high current such as the surge current.

In addition, the fusing voltage is supplied to both the electrical fuse 4 and the gate of the fusing transistor 5 from the same node (that is, the other terminal of the protection element 3) in the present embodiment, when the electrical fuse 4 is to be blown. This allows surely blowing the electrical fuse 4. A more specific description is given in the following.

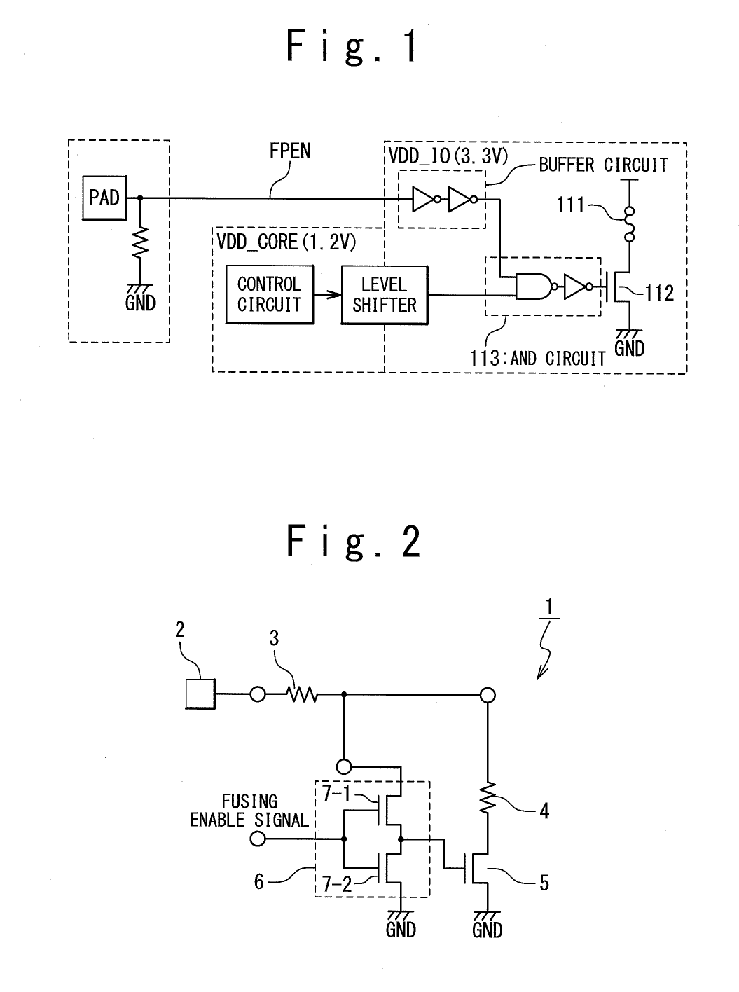

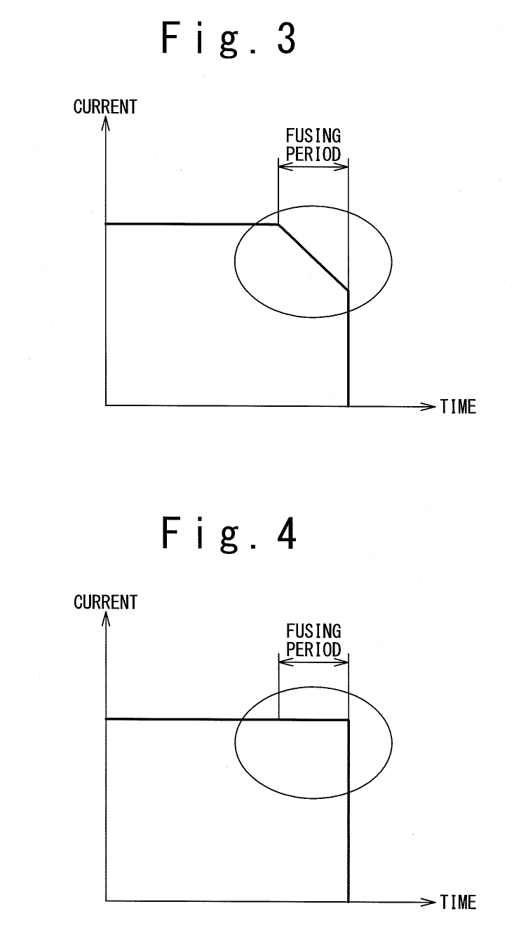

FIG. 3 is a graph showing an comparative example of the time-dependent change in the current fed the electrical fuse 4 in the conventional circuit conventional shown in FIG. 1, in which voltages are separately applied to the electrical fuse 4 and the gate of the fusing transistor 5. As shown in FIG. 3, the electrical fuse 4 starts being blown when a certain time passes since the current injection is started. When the electrical fuse 4 starts being blown, the resistance value of the electrical fuse 4 increases and this causes a decrease in the current fed to the electrical fuse 4. The decrease in the current fed to the electrical fuse 4 makes it difficult to surely blow the electrical fuse 4.

On the other hand, FIG. 4 is a graph showing a time-dependent change in the current fed to the electrical fuse 4 in this embodiment. In this embodiment, similarly to the conventional circuit configuration, the resistance value of the electrical fuse 4 increases when the electrical fuse 4 starts being blown. As a result, the voltage outputted from the output end (that is, the other end) of the protection element 3 is raised. That is, the voltage level of the fusing voltage is raised. As a result, the voltage applied to the gate of the fusing transistor 5 is also raised. This allows suppressing the decrease in the current flowing through the fusing transistor 5. As a result, the current applied to the electrical fuse 4 is kept constant as shown in FIG. 4. As thus described, the configuration of the electrical fuse circuit of this embodiment allows surely blowing the electrical fuse 4.

In summary, the electrical fuse circuit of this embodiment effectively protects the power source 2 from the surge current in blowing the electrical fuse 4. In addition, the electrical fuse circuit of this embodiment allows surely blowing the electrical fuse 4. The improvement of the blowing reliability of the electrical fuse 4 effectively improves the yield of a memory device using redundancy and reliability of inherent IDs stored in a storage device.

It is apparent that the present invention is not limited to the above embodiments, but may be modified and changed without departing from the scope of the invention.

What is claimed is:

1. An electrical fuse circuit, comprising:
a protection element having a first terminal connected to a power source and outputting a fusing voltage from a second terminal;
an electrical fuse having a third terminal connected to said second terminal of said protection circuit; and
a fusing transistor connected between said electrical fuse and ground to switch a current through said electrical fuse,
wherein said second terminal of said protection element is connected to a gate of said fusing transistor.

2. The electrical fuse circuit according to claim 1, further comprising:
a fusing enable circuit connected between said second terminal of said protection element and said gate of said fusing transistor,
wherein said fusing enable circuit is responsive to a fusing enable signal for switching an electrical connection between said second terminal of said protection element and said gate of said fusing transistor.

3. The electrical fuse circuit according to claim 1, wherein said protection element is a resistor element.

4. The electrical fuse circuit according to claim 3, wherein said resistor element is formed of polysilicon.

5. A method of operating an electrical fuse circuit, comprising:
feeding a power source voltage to a first terminal of a protection element to output a fusing voltage from a second terminal of said protection element;
feeding said fusing voltage to a third element of an electrical fuse; and
switching a current through said electrical fuse by switching a fusing transistor connected between a fourth terminal of said electrical fuse and ground,
wherein said switching the current through said electrical fuse includes feeding said fusing voltage to a gate of said fusing transistor.

6. The method according to claim 5, wherein said switching the current through said electrical fuse further includes:
switching an electrical connection between said second terminal of said protection element and said gate of said fusing transistor in response to a fusing enable signal.
